(19) United States
(12) Patent Application Publication
(10) Pub. No.: US 2025/0125858 A1
(43) Pub. Date: Apr. 17, 2025

(54) BEAM MANAGEMENT

(71) Applicant: Nokia Technologies, Espoo (FI)

(72) Inventors: Simon SVENDSEN, Aalborg (DK); Christian ROM, Aalborg (DK); Sami-Jukka HAKOLA, Oulu (FI); Juha Pekka KARJALAINEN, Oulu (FI); Mihai ENESCU, Espoo (FI)

(21) Appl. No.: 18/695,458

(22) PCT Filed: Oct. 14, 2021
(86) PCT No.: PCT/EP2021/078540

§ 371 Date: Mar. 26, 2024

(51) Int. Cl. H04B 7/08; H04B 17/318

(52) U.S. Cl. CPC H04B 7/088; H04B 17/318

(57) ABSTRACT

Examples of the disclosure beam management within networks comprising User Equipments (UEs) that can be configured to receive power from different beams. The UEs can be configured to report at least one Primary-Angular Power Area (P-APA) and an indication of the availability of at least one Secondary Useable-Angular Power Area (SU-APA) for the UE. An Angular Power Area comprises a range of angular directions from which the UE is receiving power from a node apparatus and the SU-APA comprises a different area to the P-APA.

### TECHNOLOGICAL FIELD

Examples of the disclosure relate to beam management. Some relate to beam management within networks comprising User Equipments (UEs) that can be configured to receive power from different beams.

### BACKGROUND

Beam management can be used to reduce losses between a UE and access nodes such as a Base Station (gNB). Beam management can provide for improved alignment of beams between the UE and the access nodes.

### BRIEF SUMMARY

According to various, but not necessarily all, examples of the disclosure there is provided a User Equipment (UE) comprising:
at least one processor; and
at least one memory including computer program code the at least one memory and the computer program code configured to, with the at least one processor, cause the UE at least to perform:
reporting at least one Primary-Angular Power Area (P-APA) and an indication of the availability of at least one Secondary Useable-Angular Power Area (SU-APA) for the UE wherein an Angular Power Area comprises a range of angular directions from which the UE is receiving power from a node apparatus and the SU-APA comprises a different area to the P-APA.

If no SU-APAs are receiving power above a threshold level the UE may be configured to report that no SU-APAs are available.

The UE may be configured to receive an indication of the threshold level from a node apparatus.

If one or more SU-APAs are receiving power above a threshold level the UE may be configured to report that one or more SU-APAs are available.

The UE may be configured to report the P-APA and the indication of the availability of at least one SU-APA to a node apparatus.

The report may comprise a list of APAs wherein the order of the APAs within the list indicates whether or not an APA is a P-APA or an SU-APA.

The reporting may comprise one or more bits within a channel state report message wherein the one or more bits indicate an availability of different APAs.

The channel state report may comprise a Reference Signal Received Power (RSRP) reporting and wherein the one or more bits associate reported Synchronisation Signal Block (SSB) indices to a P-APA or an SU-APA.

According to various, but not necessarily all, examples of the disclosure there is provided a method comprising:
reporting at least one Primary-Angular Power Area (P-APA) and an indication of the availability of at least one Secondary Useable-Angular Power Area (SU-APA) for a UE wherein an Angular Power Area comprises a range of angular directions from which the UE is receiving power from a node apparatus and the SU-APA comprises a different area to the P-APA.

According to various, but not necessarily all, examples of the disclosure there is provided a computer program comprising computer program instructions that, when executed by processing circuitry, cause:
reporting at least one Primary-Angular Power Area (P-APA) and an indication of the availability of at least one Secondary Useable-Angular Power Area (SU-APA) for a UE wherein an Angular Power Area comprises a range of angular directions from which the UE is receiving power from a node apparatus and the SU-APA comprises a different area to the P-APA.

According to various, but not necessarily all, examples of the disclosure there is provided an apparatus comprising means for:
reporting at least one Primary-Angular Power Area (P-APA) and an indication of the availability of at least one Secondary Useable-Angular Power Area (SU-APA) for a UE wherein an Angular Power Area comprises a range of angular directions from which the UE is receiving power from a node apparatus and the SU-APA comprises a different area to the P-APA.

According to various, but not necessarily all, examples of the disclosure there is provided a node apparatus comprising:
at least one processor; and
at least one memory including computer program code,
the at least one memory and the computer program code configured to, with the at least one processor, cause the apparatus at least to perform:
receiving a report from a User Equipment (UE) of at least one Primary-Angular Power Area (P-APA) and an indication of the availability of at least one Secondary Useable-Angular Power Area (SU-APA) for the UE wherein an angular power area comprises a range of angular directions from which the UE is receiving power from a node apparatus and the SU-APA comprises a different area to the P-APA.

The at least one processor and at least one memory may be configured to perform adjusting a threshold power for a UE in identifying SU-APAs based on the received report.

The at least one processor and at least one memory may be configured to perform enabling one or more additional transmission configurations where the additional transmission configurations make use of one or more reported SU-APAs.

The at least one processor and at least one memory may be configured to perform requesting an increase in the number of SSBs reported base on the received report.

According to various, but not necessarily all, examples of the disclosure there is provided a method comprising:
receiving a report from a User Equipment (UE) of at least one Primary-Angular Power Area (P-APA) and an indication of the availability of at least one Secondary Useable-Angular Power Area (SU-APA) for the UE wherein an angular power area comprises a range of angular directions from which the UE is receiving power from a node apparatus and the SU-APA comprises a different area to the P-APA.

According to various, but not necessarily all, examples of the disclosure there is provided a computer program comprising computer program instructions that, when executed by processing circuitry, cause:
receiving a report from a User Equipment (UE) of at least one Primary-Angular Power Area (P-APA) and an indication of the availability of at least one Secondary Useable-Angular Power Area (SU-APA) for the UE wherein an angular power area comprises a range of angular directions from which the UE is receiving power from a node apparatus and the SU-APA comprises a different area to the P-APA.

According to various, but not necessarily all, examples of the disclosure there is provided a node apparatus comprising means for:
receiving a report from a User Equipment (UE) of at least one Primary-Angular Power Area (P-APA) and an indication of the availability of at least one Secondary Useable-Angular Power Area (SU-APA) for the UE wherein an angular power area comprises a range of angular directions from which the UE is receiving power from a node apparatus and the SU-APA comprises a different area to the P-APA.

### BRIEF DESCRIPTION

Some examples will now be described with reference to the accompanying drawings in which:

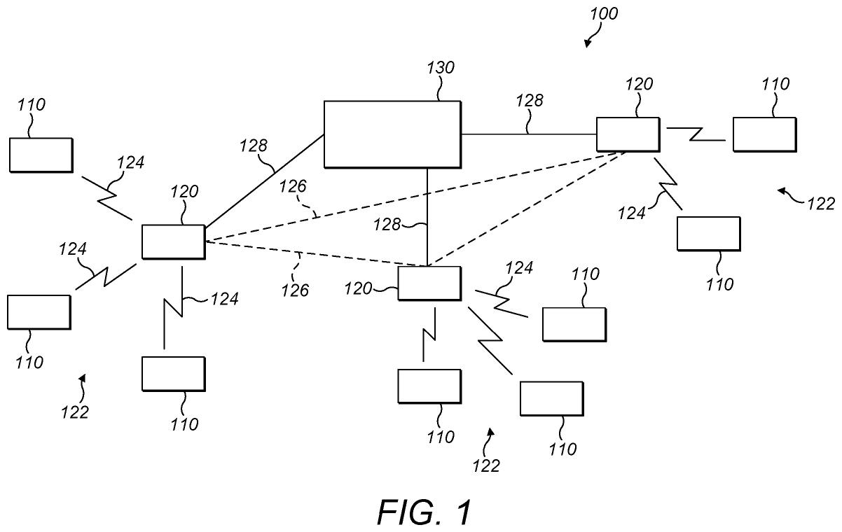

FIG. 1 shows an example network;

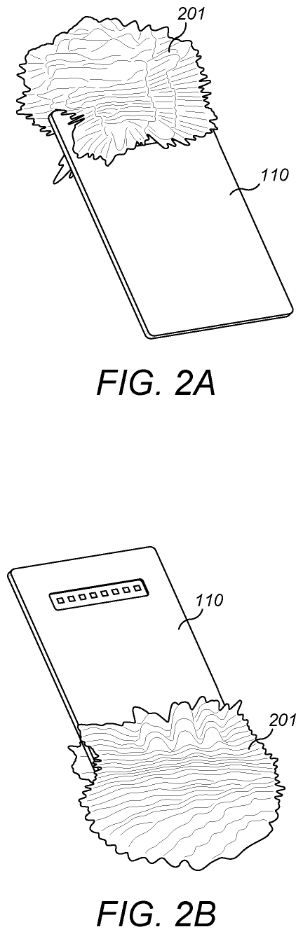

FIG. 2 shows example radiation patterns for a UE;

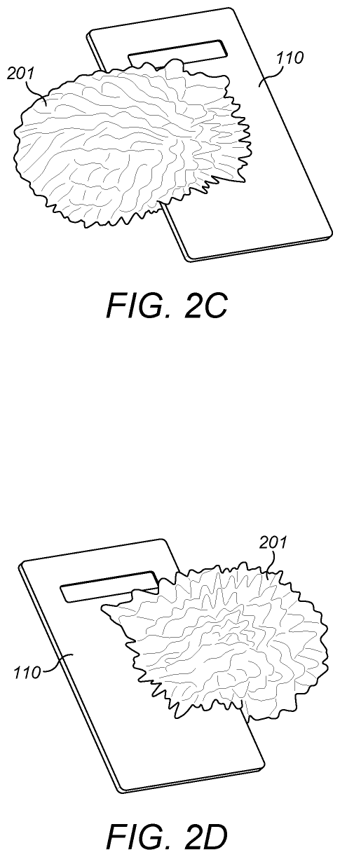

FIGS. 3A to 3E show example angular power areas;

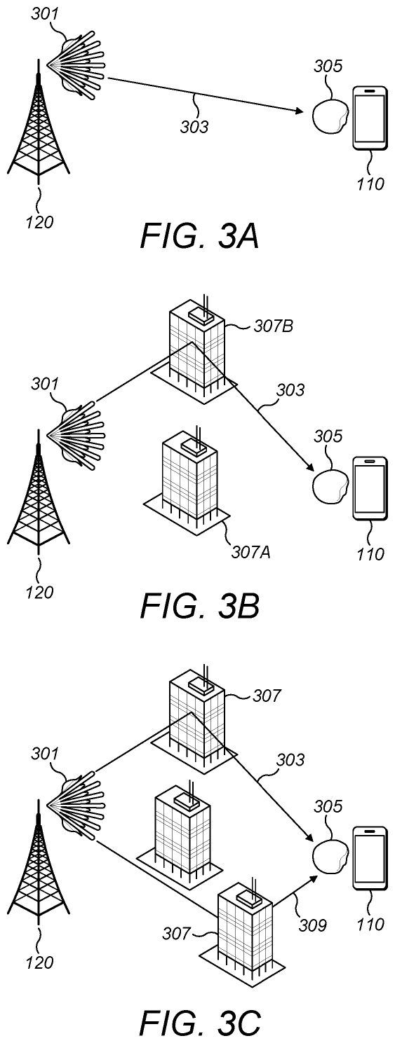

FIGS. 4A and 4B show example methods;

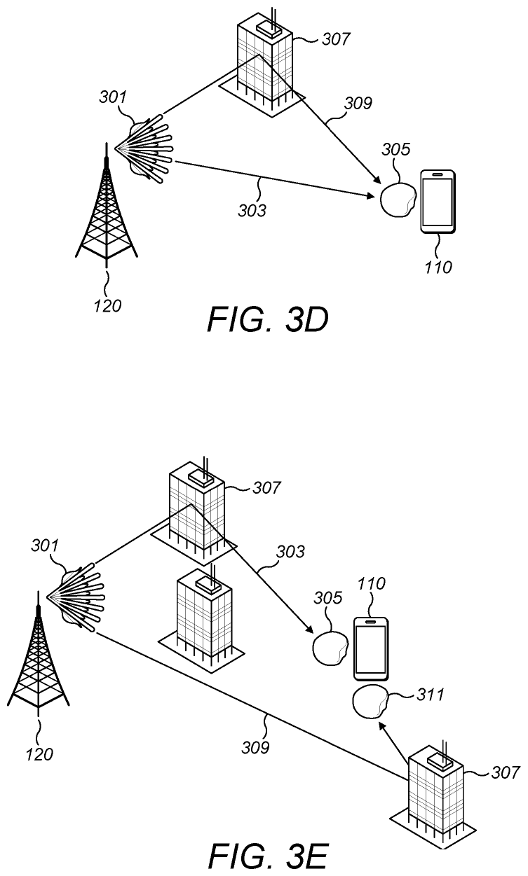

FIG. 5 shows an example signaling chart;

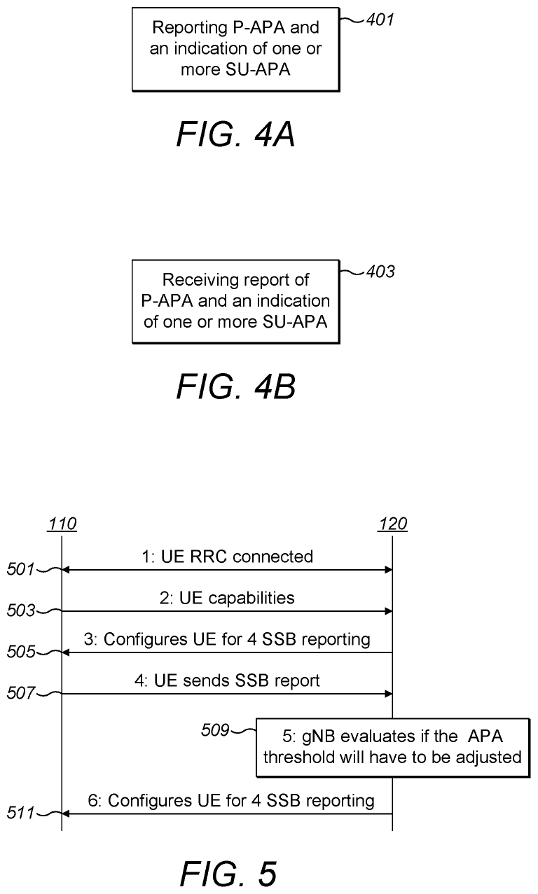

FIG. 6 shows an example method for determining availability of SU-APAs;

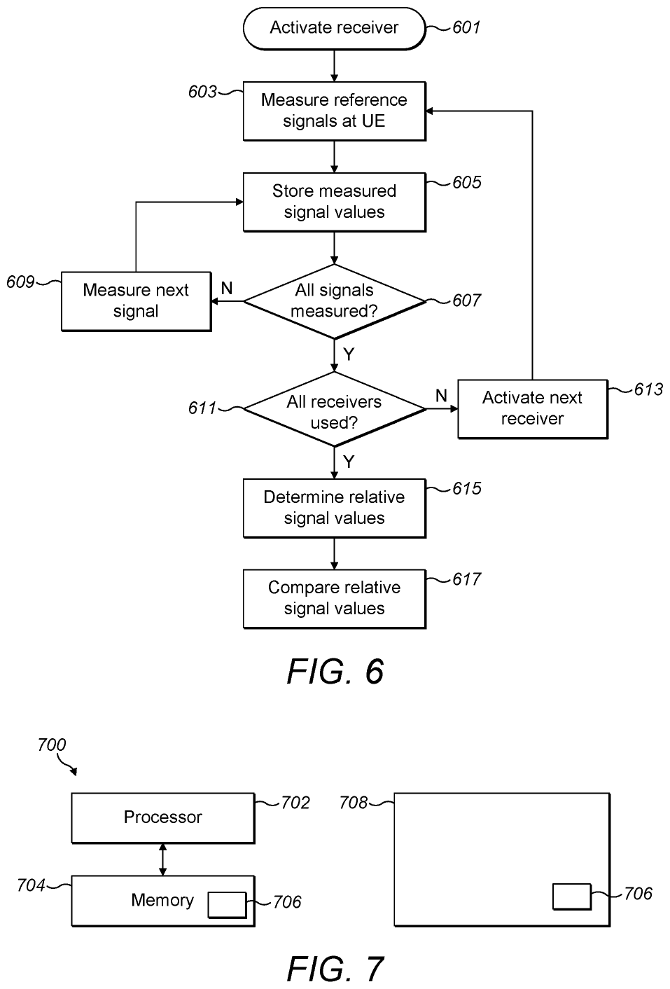

FIG. 7 shows an example controller.

### DEFINITIONS

APA Angular Power Area
CC Component Carrier
CSI Channel State Information
CSI-RS Channel State Information-Reference Signal
DL Down-Link
FS Free Space
gNB NR base station
LOS Line of Sight
N-LOS None-LOS
P-APA Primary-APA
PBCH Physical Broadcast Channel
PDSCH Physical Downlink Shared Channel
QCL Quasi Co-Location
RSRP Reference Signal Received power
SS Synchronisation Signals
SSB Synchronisation Signal Block
SU-APA Secondary Useable APA
TCI Transmission Configuration Indicator
TRP Transmission/Reception point
UE User Equipment
UL Up-Link

### DETAILED DESCRIPTION

FIG. 1 illustrates an example of a network 100 comprising a plurality of network nodes including terminal nodes 110, access nodes 120 and one or more core nodes 130. The terminal nodes 110 and access nodes 120 communicate with each other. The one or more core nodes 130 communicate with the access nodes 120.

The one or more core nodes 130 can, in some examples, communicate with each other. The one or more access nodes 120 can, in some examples, communicate with each other.

The network 100 may be a cellular network comprising a plurality of cells 122 each served by an access node 120. In this example, the interface between the terminal nodes 110 and an access node 120 defining a cell 122 is a wireless interface 124.

The access node 120 comprises a cellular radio transceiver. The terminal nodes 110 comprise a cellular radio transceiver.

In the example illustrated the cellular network 100 is a third generation Partnership Project (3GPP) network in which the terminal nodes 110 are user equipment (UE) and the access nodes 120 are base stations.

In the particular example illustrated the network 100 is a Universal Terrestrial Radio Access network (UTRAN). The UTRAN consists of UTRAN NodeBs 120, providing the UTRA user plane and control plane (RRC) protocol terminations towards the UE 110. The NodeBs 120 are interconnected with each other and are also connected by means of the interface 128 to the Mobility Management Entity (MME) 130.

The term ‘user equipment’ is used to designate mobile equipment comprising a smart card for authentication/encryption etc such as a subscriber identity module (SIM). In other examples the term ‘user equipment’ is used to designate mobile equipment comprising circuitry embedded as part of the user equipment for authentication/encryption such as software SIM.

The NodeB can be any suitable base station. A base station is an access node 120. It can be a network element in radio access network responsible for radio transmission and reception in one or more cells to or from the user equipment.

The UTRAN can be a 4G or 5G network, for example. It can for example be a New Radio (NR) network that uses gNB or eNB as access nodes 120. New radio is the 3GPP name for 5G technology.

Such networks 100 can also comprise next generation mobile and communication network, for example, a 6G network.

The access nodes 120 can have different transmission configurations. These different transmission configurations can be defined by beams or spatial filters that are used by the access nodes 120 and the UEs 110.

A Transmission Configuration Indicator-State (TCI-State) can indicate a transmission configuration between an access node 120 and a UE 110. The TCI-State can be defined by the access node 120 when the UE 110 is in Radio Resource Control (RRC) connected mode. A TCI state can comprise the identity of the relevant cell and Bandwidth part. The TCI State can also specify the relevant Synchronisation Signals (SS)/Physical Broadcast Channel (PBCH) Block or Channel State Information (CSI) Reference Signal, and the relevant Quasi Co-Location (QCL) Type.

The network 100 can be configured so that a pool comprising of up to 64 TCI-states can be configured for Physical Downlink Control Channel (PDCCH). The network 100 can be configured so that eight of these can be active (Physical Downlink Shared Channel (PDSCH) Medium Access Control-Control Element (MAC-CE)) at the same time.

In order to select TCI-States it is useful for the access node 120 to obtain information about the beams that are being received by the UE 110. It can be useful for the access node 120 to obtain information about different angular directions that the UE 110 is receiving power from. This could be used to enable the access node 120 to switch to using a beam having a different angular direction if there is a blockage in a primary direction. For example, the access node 120 could update the TCI-state.

The UEs 110 can receive power from different directions. FIGS. 2A to 2D show simulations of free space radiation patterns for an example UE 110.

In this example the UE 110 comprises a smart phone. Other types of UE 110 could be used in other examples of the disclosure. In this case the UE 110 has a reception point or panel at each of four sides. In these examples each of the reception points or panels is configured for a wide (single patch) beam. The wide beam can be used for monitoring Synchronisation Signal Block (SSB) beams or any other suitable purpose.

FIG. 2A shows the simulated radiation pattern 201 for the top panel, FIG. 2B shows the simulated radiation pattern 201 for the bottom panel, FIG. 2C shows the simulated radiation pattern 201 for the left panel and FIG. 2D shows the simulated radiation pattern 201 for the right panel.

These radiation patterns 201 show a large amount of ripples. The ripples can be caused by standing waves excited on parts of the UE 110 such as the chassis or cover glass and/or coupling with neighboring unused panels.

The simulated radiation patterns 201 show that there are regions of overlap for the different panels where similar levels of high gain could be obtained with two or more different panels. Therefore, a UE 110 that is using wide beams to receive reference signals can have angular regions from which power can be received and for which two or more panels could have the highest, or close to the highest, antenna gain value.

An Angular Power Area APA can comprise a range of directions from which a UE 110 can receive power from an access node 120. An APA can comprise an angular range comprising a direction of arrival of one or more signals. An APA does not need to be defined precisely or in absolute values or angular ranges. A UE 110 can identify different APAs without needing to determine the actual angle of arrival of any of the signals in the APA.

In some examples different APAs can be different size. That is the angular ranges for different APAs do not need to be the same. The UE 110 does not need to know the sizes of the APAs.

In some examples the UE 110 can receives power from more than one APA. In Such examples the highest power signals can be received by a Primary-APA (P-APA) and the lower signal values can be received by one or more Secondary Useable-APAs (SU-APA).

In some examples the P-APA and the SU-APA can be received by the same panel of the UE 110. In other examples the P-APA and the SU-APA could be received by different panels.

FIGS. 3A to 3E show example APAs for a UE 110 and an indication of the panels that are used to receive the power. The UE 110 could be part of a network 100 such as the network 100 of FIG. 1.

The UE 110 could be a smartphone such as the smartphone shown in FIGS. 2A to 2D. This has four receiving panels. In this case a receiving panel can be positioned on each side of the UE 110. Other arrangements of the panels could be used in other examples.

In the examples of FIGS. 3A to 3E an access node 120 is transmitting reference signals 301 on either a single broad beam or a plurality of narrow beams. In this example the access node 120 is a gNB and the reference signals 301 comprises an SSB sweep.

The SSB beam sweep is transmitted in a plurality of different angular directions sequentially or simultaneously.

In the example of FIG. 3A the reference signal 301 is transmitted directly from the access node 120 to the UE 110 in a Line of Sight (LoS) scenario. There are no strong reflections or blockage of the reference signal 301 between the transmission of the reference signal 301 transmitted by the access node 120 on beam x and the reception of the reference signal 301 by the UE 110.

In this case the UE 110 is only receiving power from one APA. This provides a P-APA 303. In this case the left-hand side panel 305 of the UE 110 is used to receive power from the P-APA 303.

In the example of FIG. 3B the environment around the UE 110 is different compared to the example of FIG. 3A. In the example of FIG. 3B there are some buildings 307A, 307B positioned between the access node 120 and the UE 110. The building 307A blocks the Line of Sight (LoS) path between the access node 120 and the UE 110, whereby the best path now relies on a reflection of the reference signal 301 coming from a different building 307B. The path of the reflection can change the directions of the reference signal 301 so that the angle of arrival of the reference signal 301 at the UE 110 is different than the potential blocked LoS path. The blockage of the potential LoS path can also affect the best configured beam at the access node 120 so a different beam y is used.

In the example of FIG. 3B the UE 110 is still only receiving power from one APA. This provides a P-APA 303. The P-APA 303 of FIG. 3B is different to the P-APA 303 of FIG. 3A because it covers different angular ranges. However, in both cases the left-hand side panel 305 of the UE 110 is also used to receive power from the P-APA 303.

In the example of FIG. 3C more buildings 307 are comprised within the environment around the UE 110. In this example two different buildings 307 reflect different beams from the reference signal 301 towards the UE 110. Therefore, in this example the UE 110 can receive power from two different APAs related to two different beams at the access node 120.

The P-APA 303 can comprise the area from which the highest power reference signal is received. The SU-APA 309 can comprise the area from which a lower power reference signal is received. The SU-APA 309 can be designated as an SU-APA 309 if the reference signals received from that direction are above a threshold power level. The threshold power level can be set relative to the power level of the reference signals received from the P-APA 303. For example, the threshold level could be set as a fraction or percentage of the power level of the reference signals received from the P-APA 303. The threshold power level can be set by the access node 120 or by any other suitable part of the network 100.

The left-hand side panel 305 of the UE 110 is also used to receive power from both the P-APA 303 and the SU-APA 309. This can make it difficult for a UE 110 to identify whether or not a reference signal 301 is received from a P-APA 303 or an SU-APA 309 based on the panel that is used to receive the power.

In the example of FIG. 3D one of the beams from the reference signal 301 is transmitted directly to the UE 110 without any reflections. Another of the beams from the reference signal 301 is reflected from a building 307 and the reflection directs it towards the UE 110.

In this example the reference signal 301 is transmitted directly to the UE 110 without any reflections has a higher power level when it is received by the UE 110. The area from which this reference signal 301 is received is therefore designated as the P-APA 303. The reference signal 301 is reflected from the building 307 towards the UE 110 has a lower power level when it is received by the UE 110. The area from which this reference signal 301 is received is therefore designated as the SU-APA 309.

In the example of FIG. 3D the left-hand side panel 305 of the UE 110 is also used to receive power from both the P-APA 303 and the SU-APA 309. This can make it difficult for a UE 110 to identify whether or not a reference signal 301 is received from a P-APA 303 or an SU-APA 309 based on the panel that is used to receive the power.

In the example of FIG. 3E two beams from the reference signal 301 are reflected from a building 307 and directed it towards the UE 110.

The reference signal that takes the shortest path from the access node 120 to the UE 110 has a higher power level when it is received by the UE 110. The area from which this reference signal 301 is received is therefore designated as the P-APA 303. The reference signal 301 that takes a longer path has a lower power level when it is received by the UE 110. The area from which this reference signal 301 is received is therefore designated as the SU-APA 309.

In the example of FIG. 3D the left-hand side panel 305 of the UE 110 is used to receive power from the P-APA 303 but the bottom panel 311 of the UE 110 is used to receive power from the SU-APA 309. In such cases the UE 110 could identify whether or not a reference signal 301 is received from a P-APA 303 or an SU-APA 309 based on the panel that is used to receive the power.

FIGS. 4A and 4B show methods that can be performed by a UE 110 and an access node 120 when it has been determined that a UE 110 is receiving power from a P-APA and one or more SU-APAs.

FIG. 4A shows an example method that could be performed by a UE 110. The UE 110 could be a smartphone as shown in FIG. 2A to 2D or any other suitable type of UE 110. The UE 110 could be in a network 100 as shown in FIG. 1 or any other suitable type of network.

The method comprises, at block 401, reporting at least one Primary-Angular Power Area (P-APA) 303 and an indication of the availability of at least one Secondary Useable-Angular Power Area (SU-APA) 309 for the UE 110.

The APAs comprise a range of angular directions from which the UE 110 is receiving power from an access node 120 such as a gNB. The SU-APA 309 comprises a different area to the P-APA 303. The APAs can comprise any arbitrary directions. The actual APAs do not need to be determined. That is the UE 110 does not need to determine the angle of arrival of the beams it is sufficient for the UE 110 to determine that the SU-APA 309 is different to the P-APA 303. FIG. 6 shows an example method that can be used to identify P-APAs 303 and SU-APAs 309. Other methods could be used in other examples of the disclosure.

The UE 110 can be configured to send the report in response to determining whether or not one or more SU-APAs 309 are available. The UE 110 can be configured to determine that an SU-APA 309 is available if an APA other than the P-APA 303 is being used to receive a reference signals and those reference signals have a power level that is above a threshold level but lower than the power level of signals received from the P-APA 303.

The threshold can be defined relative to the power level of the reference signals received from the P-APA 303. For example, the threshold could be defined as within 10 dB, or any other suitable value, of the power received from the P-APA. The threshold level can be set by the access node 120 or any other suitable part of the network 100.

The UE 110 can be configured to receive an indication of the threshold power level from the access node 120. The UE 110 can then use the received threshold power to determine whether or not there are any SU-APAs 309 for the UE 110.

In some examples the UE 110 can be configured so that the report only indicates that an SU-APA 309 is available if the UE 110 detects that one or more SU-APAs are receiving power above the threshold level. If the UE 110 does not detect any of the APAs other than the P-APA are receiving power above the threshold level then the report does not indicate the availability of any SU-APAs 309. If the UE 110 detects that there are a plurality of SU-APAs 309 receiving power above the threshold then the report can indicate the plurality of SU-APAs 309 or just a selected subset of the SU-APAs 309. The selected subset of the SU-APAs 309 can be selected based on the received power levels or any other suitable criteria.

The report is provided from the UE 110 to an access node 120 such as a gNB or any other suitable part of the network.

Any suitable format can be used for the report and the indication of the P-APAs 303 and the SU-APAs 309. In some examples the report can comprise a list of APAs wherein the order of the APAs within the list indicates whether or not an APA is a P-APA 303 or an SU-APA 309. The format and the order of the APAs within the list can be pre-agreed. For instance, it can be pre-agreed that the first APA in the list is a P-APA 303 and a second or any subsequent APAs in the list can be SU-APAs 309. If no subsequent APAs are included in the list after the P-APA 303 then this can indicate that there are no SU-APAs 309. The UE 110 can be configured so that Only SU-APAs 309 that are above the threshold power level appear in the list.

In some examples the report can comprise one or more bits within a channel state report message. In such examples each of the one or more bits indicate an availability of different APAs. The channel state report can comprise Reference Signal Received Power (RSRP) report. The one or more bits can associate reported Synchronisation Signal Block (SSB) indices to a P-APA 303 or an SU-APA 309.

The report does not need to comprise a definition of the APAs. That is, the report does not need to provide values, either absolute or relative, for the angular ranges covered by the APAs. It is sufficient to provide an indication that a first reference signal is received from a first area and a second reference signal is received from a second, different area.

FIG. 4B shows a method corresponding to the method of FIG. 4A. The example method of FIG. 4B could be performed by a node apparatus. The node apparatus could be an access node 120 or a controller within an access node 120 or any other suitable apparatus. The access node 120 could be configured to communicate with the UE 110 in a network 100 such as the network shown in FIG. 1 or any other suitable type of network.

The method comprises, at block 403, receiving a report from a UE 110 of at least one P-APA 303 and an indication of the availability of at least one SU-APA 309 for the UE 110. The report could be transmitted from a UE 110 as shown in FIG. 4A.

In some examples the report might not comprise any indications of any available SU-APAs 309. If the report from the UE 110 does not indicate any SU-APAs 309 then it could be that the environment around the UE 110 only supports a single path and the UE 110 has not identified any SU-APA 309. This would be the case in the examples shown in FIGS. 3A and 3B.

Alternatively, it could be that there is more than one path between the access node 120 and the UE 110 but the power levels for the secondary paths are below the levels of the threshold level. In such cases the access node 120 can either accept that there are no SU-APAs 309 or can reduce the threshold level for the SU-APAs 309. For example, the threshold power level could be reduced from being within 10 dB of the signals received by the P-APA 303 to within 15 dB of the signals received by the P-APA 303. The access node 120 can transmit a message indicative of the new threshold level to the UEs 110. This can enable the UEs 110 to use the new threshold to identify any SU-APAs 309.

The node apparatus can be configured to request an increase in the number of SSBs reported. This can mean that more SSBs are reported by the UE 110 which will enable SSBs with lower RSRP values to be included within the report. The request for additional SSBs can be based on the report received from the UE 110. For instance, if the report indicates that all reported SSBs are from the P-APA then the request to increase the number of SSBs reported could be made. Whereas if the report from the UE 110 associates one or more SSB indices with an SU-APA 309 the node apparatus does not need to request an increase in the number of SSBs reported.

If the report indicates one or more SU-APAs 309 then the node apparatus can be configured to enable one or more additional transmission configurations. The transmission configurations can be configured to transmit Downlink (DL) information to the UE 110. The additional transmission configurations make use of one or more of the reported SU-APAs 309. The additional transmission configurations can comprise one of more TCI-states or any other suitable configurations.

Different configurations for the report can be used in different examples of the disclosure.

In some examples the UE 110 can be configured by the access node 120 to report the SSB index and RSRP values for the x number SSB's (1 to 64) received with the highest RSRP values. In this example the report can comprise a bit sequence within the report from the UE 110. The sequence of the bits can inform the access node 120, which of the reported SSB indices corresponds to the best SU-APA 309 for the UE 110.

As an example, a UE 110 could be configured to report the SSB indices and RSRP values of the four best received SSBs. The best received SSBs could be those with the highest power level. The choice of the four SSBs can be made using RSRP as the only criteria. Different SSBs can be received with similar power and can arrive from the same APAs at the UE 110. This means that the access node 120 cannot assume that UE 110 receives the second best reported SSB from a different APA to the best reported SSB. To account for this the UE 110 can add a two-bit value to the SSB report (Information Element (IE)) indicating a possible SU-APA 309. Examples of two-bit values that can be used to indicate SU-APAs 309 could be:
00→The P-APA is the only detected APA
01→SU-APA is the second best reported SSB index
10→SU-APA is the third best reported SSB index
11→SU-APA is the fourth best reported SSB index

In such examples, if the UE 110 reports a two-bit value of 00 this will indicate that The UE 110 receives all reported SSB indices from the same APA. If the UE 110 reports any other two-bit values this this will indicate that the specific SSB is received from the SU-APA 309.

Once the access node 120 has been informed of the SSB indices associated with an SU-APA 309 the access node 120 can use this information to configure an additional transmission configuration. The additional transmission configuration could be A TCI-state with a CSI beam positioned within the angular range of the SU-APA 309 associated with the reported SSB index.

If the access node 120 receives a report indicating that the P-APA is the only detected APA then this could mean the environment around the UE 110 only supports one path between the access node 120 and the UE 110 and so the UE 110 has not identified any SU-APA 309. Alternatively, it could mean that the UE 110 has identified and SU-APA 309 but that the RSRP value of the for the SSBS from the SU-APA 309 are below the levels for the SSBs that have been reported.

In such cases the access node 120 can now either accept that there are no SU-APAs 309 or can reduce the threshold for the SU-APAs. The threshold for the SU-APAs can be reduced by increasing the number of SSB indices that are reported.

In some examples the bit sequences can be added to the MeasResultListNR (TS-38.331, sec. 6.3.2) Information Element, as indicated below:

MeasResultListNR ::= SEQUENCE (SIZE (1..maxCellReport)) OF MeasResultNR

| | |
|---|---|
| MeasResultNR ::= SEQUENCE { | |
| physCellId | PhysCellId OPTIONAL, |
| measResult SEQUENCE { | |
| cellResults SEQUENCE{ | |
| resultsSSB-Cell | MeasQuantityResults OPTIONAL, |
| resultsCSI-RS-Cell | MeasQuantityResults OPTIONAL |
| }, | |
| rsindexResults SEQUENCE{ | |
| resultsSSB-Indexes | ResultsPerSSB-IndexList OPTIONAL, |
| resultsCSI-RS-Indexes | ResultsPerCSI-RS- |
| IndexList OPTIONAL | |
| result-SU-APA | BIT STRING (SIZE (2...6*)) OPTIONAL |
| } OPTIONAL | |
| }, | |
| ..., | |
| [[ | |
| cgi-Info | CGI-Info OPTIONAL |
| ]] | |
| } | |

The size of the bit string (*) used to indicate the SU-APA 309 can be scaled with the number of SSBs the UE 110 is configured to report (maxNrofIndexesToReport2). This could include all 64 SSBs, so the number of needed bits could be as high as 6 for those configurations. However, in most cases two or three bits will be sufficient be most scenarios.

In some examples the UE 110 can be configured with the capability to report that it supports APAs. In such examples the P-APA 303 and the SU-APA 309 could be associated with specific reposted sequence indices. An example of such an association is given in table 1:

TABLE 1

| Reported | | | |
|---|---|---|---|
| Sequence | Reported | Reported | |
| Index | SSB Index | RSRP Values | APA association |
| #0 | SSB#x | RSRP = −100 dBm | Strongest P-APA |
| #1 | SSB#x | RSRP = −104 dBm | 2^{nd} Strongest P-APA |
| #2 | SSB#y | RSRP = −106 dBm | Strongest SU-APA |
| #3 | SSB#z | RSRP = −10b dBm | 2^{nd} Strongest SU-APA |

In this example the first Sequence Index (SI #0) is used for the best SSB received from the P-APA 303. This will be the overall best SSB. The SSB may be the best in that it has the highest RSRP value. Other criteria for determining the best SSB could be used in other examples.

The second Sequence Index (SI #1) is used for the second best SSB. This is also received from the P-APA 303. This could be used where both the first best SSB and the second best SSB are received from the same, or similar directions. In such cases if there is a blockage affecting the first best SSB there is a significant probability that it is also affecting the second best SSB.

The third Sequence Index (SI #2) is used for the third best SSB and the fourth Sequence Index (SI #3) is used for the fourth best SSB. These are received from an SU-APA 309. The third and fourth Sequence Indices are used if the UE 110 detects an SSB received from the SU-APA 309 that is above the given threshold.

If the access node 120 receives a report indicating that the P-APA is the only detected APA then this could mean the environment around the UE 110 only supports one path between the access node 120 and the UE 110 and so the UE 110 has not identified any SU-APA 309. Alternatively, it could mean that the UE 110 has identified and SU-APA 309 but that the RSRP value of the for the SSBS from the SU-APA 309 are below the levels for the SSBs that have been reported.

In such cases the access node 120 can now either accept that there are no SU-APAs 309 or can reduce the threshold for the SU-APAs 309 to see if the UE 110 will report an SU-APA 309 at the lower threshold.

FIG. 5 shows an example signaling chart that can be used in examples where the UE 110 has the capability to report APAs. The signaling chart shows a method that can be implemented by a system comprising a UE 110 and an access node 120 such as a gNB. The UE 110 and the access node 120 can be within a network 100 such as the network 100 of FIG. 1 or any other suitable type of network.

At block 501 the access node 120 and the UE 110 configure the UE 110 in an RRC connected state. Any suitable process can be used to configured the UE 110 in the RRC connected state.

At block 503 the UE 110 transmits a report indicative of the UE 110 capabilities to the access node 120. This report can indicate the format or data structure that will be used to report the availability of one or more SU-APAs 309. For example it could indicate the Sequence Indices and the APAs associated with the indices. These could be as shown in table 1 or could be in any other suitable format.

At block 505 the access node configures the UE 110 for SSB reporting. This comprises the access node 120 providing an indication of the threshold level of power that is to be used to determine whether or not an APA is an SU-APA 309.

At block 507 the UE sends the SSB report. The SSB report can comprise one or more bits indicating a P-APA 303 and may also comprise one or more bits indicating the availability of one or more SU-APAs 309. The bits can comprise Sequence Indices as described above or any other suitable information.

At block 509 the Access node 120 can determine whether or not the report identifies any SU-APAs 309. For example, it can determine if the third or fourth Sequence Indices from table 1 have been used.

If no SU-APAs 309 are identified then the access node 120 can reduce the threshold power level for identifying an APA as an SU-APA 309.

At block 511 the access node 120 configures the UE 110 for SSB reporting. This comprises the access node 120 providing an indication of the new threshold level of power that is to be used to determine whether or not an APA is an SU-APA 309. The new threshold power is lower than the first threshold power that was used at block 505.

Once the new threshold levels are received by the UE 110 block 507 to 511 can be repeated as appropriate. Blocks 507 to 511 can be repeated until one or more SU-APAs are identified.

If at block 509 it is determined that one or more SU-APAs 309 are available then the access node 120 can be configured to make use of the one or more SU-APAs 309.

For instance, one or more additional transmission configurations that use an SU-APA 309 could be enabled. In examples of the disclosure the SU-APA 309 can be associated with an SSB beam index and this index can be used to enable the additional transmission configuration.

FIG. 6 shows an example method for determining whether or not one or more SU-APAs 309 are available. The example method of FIG. 6 could be performed by a UE 110.

The UE 110 could be a smartphone as shown in FIGS. 2A to 2D or any other suitable type of UE 110.

At block 601 the method comprises activating a first set of receivers of the UE 110, where a set of receives could be one or multiple. The set of receivers could be one or multiple of the panels or beams within the UE 110.

At block 603 a reference signal is received by the UE 110 and measured. The received power levels of the reference signal could be measured. The reference signal can be any suitable type of reference signal. For instance, the reference signal could be an SSB signal or a CSI-RS signal.

The measured signal values could comprise the received power levels of the reference signal or any other suitable type of values. For example, the measured signal values could comprise the RSRP values or any other suitable type of values.

The measured signal values are stored at block 605. The measured signal values can be stored so that they can be used to compare different signals at a later point in time.

The measured signal values can be stored so that they can be used to compare different signals after all of the reference signals have been received and measured.

The measured signal values can be stored in a memory of the UE 110 or in any other suitable storage location.

At block 607 it is determined whether or not all of the expected reference signals have been measured. If all of the signals have not been measured then the process moves to block 609 and the next reference signal is measured. Once the next reference signal has been measured the process returns to block 605 to store the measured value.

If, at block 607, it is determined that all of the expected reference signals have been measured then the process moves to block 611 and it Is determined whether or not all receivers have been used.

If all of the receivers have not been used then the process moves to block 613 and the next receiver is activated. Once the next has been activated the process returns to block 603 to measure the reference signals that have been received by the next receiver.

If, at block 611, it is determined that all of the receivers have been used then the process moves to block 615 and relative signal values are determined.

Any suitable process can be used to determine the relative signal values. The relative signal values can comprise the difference in the power levels for a given reference signal received on the different receivers. For example, the relative signal values could comprise the differences in the RSRP values for a given SSB index for each of the receivers.

In some examples the method can comprise generating a vector for at least some of the received reference signals. The values within the vector can comprise reference signal receive power (RSRP) values for two or more the receivers used.

At block 617 the relative signal values can be compared. This enables the relative signal strengths of the received signals to be compared. In some examples this can be comparing the vectors that might formed at block 615.

Reference signals can be classed as being from the same APA if they have differences that are similar to each other. For instance, two or more vectors can be compared and if they are within a threshold of each other the reference signals corresponding to the vectors can be considered to be received from the same APA. However, if the vectors are not within a threshold of each other then the reference signals can be classed as being from different APAs.

In some examples the method can comprise grouping reference signals to different APAs. Reference signals with similar differences between measured values can be classified together in the same group. This grouping can be used to identify which reference signals have been received by a P-APA 303 and which have been received by an SU-APA 309.

If it is determined that the reference signals are received from different APAs then a P-APA 303 and one or more SU-APAs can be identified based on received power levels or any other suitable criteria.

The APAs do not need to be defined precisely. That is, the angular ranges covered by the APAs do not need to be determined either in absolute terms or relative terms.

It is sufficient to identify that a P-APA 303 is different from an SU-APA 309. This can enable the P-APA 303 and the SU-APA 309 to be identified without any known and/or pre-characterized spatial filtering at the UE 110. This can enable the UE 110 to identify the P-APA 303 and the SU-APA 309 in any conditions, including conditions in which the users' hands are blocking one or more panels of the UE 110.

In the example of FIG. 6 the reference signals have been received sequentially. In other examples the reference signals could be received simultaneously, or substantially simultaneously.

Examples of the disclosure therefore provide the increased robustness and/or reliability for communications between a UE 110 and an access node 120 because the access node 120 is made aware of an SU-APA 309. The SU-APA 309 can be associated with an SSB beam index so that the access node can use this information to set up an additional transmission configuration.

Examples of the disclosure also provide for a short time for finding and setting up the additional transmission configuration because the access node 120 can already be informed of the one or more SU-APAs 309 that could be used. There is no need for any more additional reference signals to be transmitted by the access node 120 in order to find the SU-APAs 309.

FIG. 7 illustrates an example of a controller 700. The controller 700 could be provided within an apparatus such as a UE 110 or a gNB. Implementation of a controller 700 may be as controller circuitry. The controller 700 may be implemented in hardware alone, have certain aspects in software including firmware alone or can be a combination of hardware and software (including firmware).

As illustrated in FIG. 7 the controller 700 can be implemented using instructions that enable hardware functionality, for example, by using executable instructions of a computer program 706 in a general-purpose or special-purpose processor 702 that may be stored on a computer readable storage medium (disk, memory etc) to be executed by such a processor 702.

The processor 702 is configured to read from and write to the memory 704. The processor 702 may also comprise an output interface via which data and/or commands are output by the processor 702 and an input interface via which data and/or commands are input to the processor 702.

The memory 704 stores a computer program 706 comprising computer program instructions (computer program code) that controls the operation of the apparatus when loaded into the processor 702. The computer program instructions, of the computer program 706, provide the logic and routines that enables the apparatus to perform the methods illustrated in FIGS. 3 to 6 The processor 702 by reading the memory 704 is able to load and execute the computer program 706.

In examples where the controller 700 is provided within a UE 110 the controller 700 therefore comprises: at least one processor; and at least one memory including computer program code; the at least one memory and the computer program code configured to, with the at least one processor, cause the apparatus at least to perform; reporting at least one Primary-Angular Power Area (P-APA) and an indication of the availability of at least one Secondary Useable-Angular Power Area (SU-APA) for the UE wherein an Angular Power Area comprises a range of angular directions from which the UE is receiving power from a node apparatus and the SU-APA comprises a different area to the P-APA.

In examples where the controller 700 is provided within an access node 120 the controller 700 therefore comprises: at least one processor; and at least one memory including computer program code; the at least one memory and the computer program code configured to, with the at least one processor, cause the apparatus at least to perform;
receiving a report from a User Equipment (UE) of at least one Primary-Angular Power Area (P-APA) and an indication of the availability of at least one Secondary Useable-Angular Power Area (SU-APA) for the UE wherein an angular power area comprises a range of angular directions from which the UE is receiving power from a node apparatus and the SU-APA comprises a different area to the P-APA.

The computer program 706 may arrive at the apparatus or network apparatus via any suitable delivery mechanism 708. The delivery mechanism 708 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 706. The delivery mechanism may be a signal configured to reliably transfer the computer program 706. The apparatus may propagate or transmit the computer program 706 as a computer data signal.

The computer program 706 can comprise computer program instructions for causing a UE 110 to perform at least the following or for performing at least the following:
reporting at least one Primary-Angular Power Area (P-APA) and an indication of the availability of at least one Secondary Useable-Angular Power Area (SU-APA) for the UE wherein an Angular Power Area comprises a range of angular directions from which the UE is receiving power from a node apparatus and the SU-APA comprises a different area to the P-APA.

The computer program 706 can comprise computer program instructions for causing an access node 120 to perform at least the following or for performing at least the following:
receiving a report from a User Equipment (UE) of at least one Primary-Angular Power Area (P-APA) and an indication of the availability of at least one Secondary Useable-Angular Power Area (SU-APA) for the UE wherein an angular power area comprises a range of angular directions from which the UE is receiving power from a node apparatus and the SU-APA comprises a different area to the P-APA.

The computer program instructions may be comprised in a computer program, a non-transitory computer readable medium, a computer program product, a machine readable medium. In some but not necessarily all examples, the computer program instructions may be distributed over more than one computer program.

Although the memory 704 is illustrated as a single component/circuitry it may be implemented as one or more separate components/circuitry some or all of which may be integrated/removable and/or may provide permanent/semi-permanent/dynamic/cached storage.

Although the processor 702 is illustrated as a single component/circuitry it may be implemented as one or more separate components/circuitry some or all of which may be integrated/removable. The processor 702 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions and
(c) hardware circuit(s) and or processor(s), such as a microprocessor(s) or a portion of a microprocessor(s), that requires software (e.g. firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The stages illustrated in FIGS. 3 to 6 can represent steps in a method and/or sections of code in the computer program 706. The illustration of a particular order to the blocks does not necessarily imply that there is a required or preferred order for the blocks and the order and arrangement of the block may be varied. Furthermore, it can be possible for some blocks to be omitted.

Where a structural feature has been described, it may be replaced by means for performing one or more of the functions of the structural feature whether that function or those functions are explicitly or implicitly described.

In some but not necessarily all examples, the UE 110, and the network 100 are configured to communicate data with or without local storage of the data in a memory 704 at the UE 110, or the access nodes 120 and with or without local processing of the data by circuitry or processors at the UE 110, or the access nodes 120.

The data may be stored in processed or unprocessed format remotely at one or more devices. The data may be stored in the Cloud.

The data may be processed remotely at one or more devices. The data may be partially processed locally and partially processed remotely at one or more devices.

The data may be communicated to the remote devices wirelessly via short range radio communications such as Wi-Fi or Bluetooth, for example, or over long range cellular radio links. The apparatus may comprise a communications interface such as, for example, a radio transceiver for communication of data.

The UE 110 and/or the network 100 can be part of the Internet of Things forming part of a larger, distributed network.

The processing of the data, whether local or remote, can be for the purpose of health monitoring, data aggregation, patient monitoring, vital signs monitoring or other purposes.

The processing of the data, whether local or remote, may involve artificial intelligence or machine learning algorithms. The data may, for example, be used as learning input to train a machine learning network or may be used as a query input to a machine learning network, which provides a response. The machine learning network may for example use linear regression, logistic regression, vector support machines or an acyclic machine learning network such as a single or multi hidden layer neural network.

The processing of the data, whether local or remote, may produce an output. The output may be communicated to the UE 110, and the access nodes 120 where it may produce an output sensible to the subject such as an audio output, visual output or haptic output.

The above-described examples find application as enabling components of:

automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Explicitly indicate that features from different examples (e.g. different methods with different flow charts) can be combined, to Although functions have been described with reference to certain features, those functions may be performable by other features whether described or not.

Although features have been described with reference to certain examples, those features may also be present in other examples whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1. A User Equipment (UE) comprising:
at least one processor; and
at least one memory including computer program code the at least one memory and the computer program code configured to, with the at least one processor, cause the UE at least to perform:
reporting at least one Primary-Angular Power Area (P-APA) and an indication of the availability of at least one Secondary Useable-Angular Power Area (SU-APA) for the UE wherein an Angular Power Area comprises a range of angular directions from which the UE is receiving power from a node apparatus and the SU-APA comprises a different area to the P-APA.

2. The UE as claimed in claim 1 wherein if no SU-APAs are receiving power above a threshold level the UE is configured to report that no SU-APAs are available.

3. The UE as claimed in claim 2 wherein the UE is configured to receive an indication of the threshold level from a node apparatus.

4. The UE as claimed in claim 1 wherein if one or more SU-APAs are receiving power above a threshold level the UE is configured to report that one or more SU-APAs are available.

5. The UE as claimed in claim 1 wherein the UE is configured to report the P-APA and the indication of the availability of at least one SU-APA to a node apparatus.

6. The UE as claimed in claim 1 wherein the report comprises a list of APAs wherein the order of the APAs within the list indicates whether or not an APA is a P-APA or an SU-APA.

7. The UE as claimed in claim 1 wherein the reporting comprises one or more bits within a channel state report message wherein the one or more bits indicate an availability of different APAs.

8. The UE as claimed in claim 7 wherein the channel state report comprises a Reference Signal Received Power (RSRP) reporting and wherein the one or more bits associate reported Synchronisation Signal Block (SSB) indices to a P-APA or an SU-APA.

9. A method comprising:
reporting at least one Primary-Angular Power Area (P-APA) and an indication of the availability of at least one Secondary Useable-Angular Power Area (SU-APA) for a UE wherein an Angular Power Area comprises a range of angular directions from which the UE is receiving power from a node apparatus and the SU-APA comprises a different area to the P-APA.

10. The method as claimed in claim 9 wherein if no SU-APAs are receiving power above a threshold level the UE is configured to report that no SU-APAs are available.

11-12. (canceled)

13. A node apparatus comprising:
at least one processor; and
at least one memory including computer program code,
the at least one memory and the computer program code configured to, with the at least one processor, cause the apparatus at least to perform:
receiving a report from a User Equipment (UE) of at least one Primary-Angular Power Area (P-APA) and an indication of the availability of at least one Secondary Useable-Angular Power Area (SU-APA) for the UE wherein an angular power area comprises a range of angular directions from which the UE is receiving power from a node apparatus and the SU-APA comprises a different area to the P-APA.

14. The node apparatus as claimed in claim 13 wherein the at least one processor and at least one memory are configured to perform adjusting a threshold power for a UE in identifying SU-APAs based on the received report.

15. The node apparatus as claimed in claim 13 wherein the at least one processor and at least one memory are configured to perform enabling one or more additional transmission configurations where the additional transmission configurations make use of one or more reported SU-APAs.

16. The node apparatus as claimed in claim 13 wherein the at least one processor and at least one memory are configured to perform requesting an increase in the number of SSBs reported based on the received report.

17-20. (canceled)
